(19) United States
(12) Patent Application Publication
(10) Pub. No.: US 2006/0236453 A1
(43) Pub. Date: Oct. 26, 2006

(54) Equipment for moving patient without changing patient's pose

(76) Inventor: Chen-Chuan David Rau Jao, Taipei (TW)

Correspondence Address: Chen-Chuan Jao, #505 Ren Ai St. F. 5, San Chung City, 241, TW

(21) Appl. No.: 11/111,667

(22) Filed: Apr. 22, 2005

(51) Int. Cl. A61G 7/10

(52) U.S. Cl. 5/81.1 R

(57) ABSTRACT

A patient moving equipment, which can move the patient without changing patient's pose by the interaction of the magic mattress and the moving body with each other; wherein the magic mattress is put on the stretcher, wheelchair or sickbed previously. Owing to the chain-type of magic mattress, the patient can sit or lie on the magic mattress, which can be bent by pulling up the magic sticks at certain locations of the magic mattress with the pulling hydraulic systems, so that, the patient's pose can be remained as the same when he or she will be moved with the present invention of the moving equipment. The banister, which is installed at the frame of the magic mattress, can be bent with the magic mattress at the same step and, the safety belt is installed at certain locations of the magic mattress so as to doubly ensure the security for the patient. The patient together with the magic mattress can be moved away right after leaving the stretcher, wheelchair or sickbed by the lifting hydraulic system. For meeting the length of the patient, who is lying on the sick bed, the extension slot can be stretched by the extension hydraulic system, which hangs with the pulling hydraulic hooks all over the length of the patient. The balance material is located at the bottom of the moving body is used to balance the moving body when it is loaded with the patient together with the magic mattress, however, the balance can be taken over if the moving body is mounted at a electric car or the wheelbarrow. If the moving body is mounted at the electric car or the wheelbarrow, it's not necessary to have an extra balance material to be carried with the moving body. The equipment for moving patient without changing patient's pose can be controlled by wire-control, remote-control or program-control systems. The equipment of which not only can move the patient without changing patient's post, but also can help the patient to take shower, change cloth, relax their legs or excise their feet on the ground, sit on the bedpan or water closet for crap, and it can help the patient to sit near by the dining table or write on the desk with their feet at the ground comfortably. From these wonderful functions said above, the present invention of The Equipment for Moving Patient without Changing Patient's Pose is really helpful to those patient's families, hospital's workers and the patients themselves.

The present invention of (The equipment for moving patient without changing patient's pose) comprises magic mattress and the moving body two parts; the magic mattress, which uses the bending feature of the chain to be the frame at each side, and the banister is set at one side with the chain-frame to march with the magic mattress at same step; in between of those two frames each side, there are lined up a plurality of magic sticks at the middle; the magic sticks of which are made by iron tubes covered with soft material; the magic mattress is used to put on the wheelchair, sick bed or stretcher previously. The worker, who pushes the moving body approaching the wheelchair, sick bed or stretcher with magic mattress no matter what pose the patient is on, inserts the hooks into the frame of the magic mattress at some necessary locations, and operates the pulling systems of hydraulic power in the moving body to pull up those magic sticks with hooks so as to march the pose of the patient by bending the magic mattress; after that, the worker pushes the button of the lifting hydraulic power system to lift the magic mattress together with the patient up from the wheelchair, sick bed or stretcher; after having left the wheelchair, sick bed or stretcher, the patient can be moved away without changing patient's pose by the wheels of the moving body. According to the functions of the present invention, it can also help the patient from lying down, sitting up, changing clothes, taking shower or putting feet on the ground for all kinds of activities by adjusting the length or bending the magic mattress; some of the magic sticks can be withdrew from the frame of the magic mattress at the ass portion of the patient for crap. The equipment of which can be operated by one person, or by the patient himself or herself, who still has one available hand and is skillful to operate it with a remote controller. Except of withdrawing the magic sticks from the frame for crap in advance; the moving body can be mounted on the electric car or wheelbarrow, and, all those operating procedures can be controlled by the driver.

### THE DESCRIPTION OF THE ARTS

Normally, to move the patient from the sickbed to wheelbarrow or from wheelchair to sickbed etc., no matter what those movements for patients were, they need not only manpower to be involved, but also the patient has to be forced to change their pose to support, and any change to the patient's pose must touch or press the patient's body, organs, bones or painful area; sometimes, no even one man is enough to move a heave body for diagnosis and treatment or for living requirements; the patient's transportation is the big puzzle to the patient's families, hospital's workers and the patients themselves. However, the present tools, machines or procedures for moving patients are not able to satisfy the requirements in the modern society for those people, who have to be involved. Enclosed herewith please find the collections of the patient lifting products world wide for reference.

### THE SUMMARY OF THE INVENTION

In view of the foregoing, the present inventor, who observed the movements for the patient at the hospitals carefully and found that the only way to avoid the patient's pain from movements is to know how to keep the patient's pose remaining the same. He has spent years' careful studies to the arts for evaluations and considerations, and has overcome so many difficulties on the researches, so that, the present invention of The equipment for moving patient without changing patient's pose comes out.

For achieving the function for moving patient without changing any pose simply, the construction of the present invention comprises two parts, the one is the magic mattress; the other one is the moving body.

First, the patient sits or lies on the magic mattress, which is put on the wheelchair, sick bed or stretcher beforehand; the worker pushes the moving body to approach with.

Second, the worker, who inserts the hooks into the frame of the magic mattress, holds the holders of the magic stick at some necessary locations, then, pushes the button of the pulling hydraulic power system to pull the magic sticks up by bending the magic mattress so as to march the pose of the patient, the way of which will keep the patient's pose remaining the same.

Third, the worker pushes the button of the lifting hydraulic power system controller, the magic mattress together with the patient will be lifted up from the wheelchair, sick bed or stretcher by the lifting hydraulic power system.

After having left the wheelchair, sick bed or stretcher, the magic mattress together with the patient can be moved away by the wheels of the moving body.

With the steps said above, the patient can be moved since the stretcher, which has the magic mattress on; then, from the stretcher to the operating table; to the sick bed or wheelchair etc., the patient can keep the same pose without change from those movements.

According the extra functions of the present invention with the hydraulic power systems, the patient can lie on the sick bed by stretching their legs, putting their head on the pillow, helping them to sit on the bed or chair, putting their legs on the ground, changing cloth or taking shower etc. Especially, the moving body can carry the patient to go to the toilet for crap by withdrawing the magic sticks from the magic mattress at the patient's ass portion.

The present invention of the moving body can be operated by one person, or the patient himself or herself can operate it with a remote controller if he or she is skilled enough, but the worker has to withdraw some of the magic sticks at patient's ass portion for crap in advance.

The present invention of patient's moving body can be mounted on the wheelbarrow or the electric car, all of those operating procedures can be controlled by the driver.

By means of the present invention, it will solve those problems of puzzles to the patient's families, hospital workers, and ease the patient's pains to the minimum successfully.

### THE BRIEF DESCRIPTION OF THE DRAWINGS

For understanding the present invention more clearly, reference will now be made to the following brief description of preferred embodiments taken in conjunction with the following accompanying drawings:

FIG. 1 is the top view of the magic mattress according to an embodiment of the present invention.

FIG. 2 is the analytical view of the magic mattress according to an embodiment of the present invention.

FIG. 3 is the top view of the hooker inserted into the magic mattress frame holding the magic stick according to an embodiment of the present invention.

FIG. 4 is the side view of the magic stick holding up by the pulling hydraulic power system according to an embodiment of the present invention.

FIG. 5 is the top view of the handle putting on the magic mattress frame covered by its cover according to an embodiment of the present invention.

FIG. 6 is the sketch diagram of the magic sticks withdrawing from the magic mattress according to an embodiment of the present invention.

FIG. 7 is the analytical view of the magic sticks taking off from the magic mattress according to an embodiment of the present invention.

FIG. 8 is the top view of the banister at its upward position according to an embodiment of the present invention.

FIG. 9 is the top view of the banister at its folded position according to an embodiment of the present invention.

FIG. 10 is the side view of the banister at both upward and folded position according to an embodiment of the present invention.

FIG. 11 is the stereoscopic view of the moving body according to an embodiment of the present invention.

FIG. 12 is the stereoscopic view of the slot for hanging the pulling hydraulic cylinders lifted up by the lifting hydraulic power system at the moving body according to an embodiment of the present invention.

FIG. 13 is the stereoscopic view of the slot for hanging the pulling hydraulic cylinders stretched by the extension power system at the moving body according to an embodiment of the present invention.

FIG. 14 is the stereoscopic view of the slot for hanging the pulling hydraulic cylinders lifted up by the lifting hydraulic power system and, at the same time, the extension slots stretched by the extension power system at the moving body according to an embodiment of the present invention.

FIG. 15 is stereoscopic view of the slot for hanging the pulling hydraulic cylinders and the extension slots stretched by the extension power system according to an embodiment of the present invention.

FIG. 16 is the perspective view of the pulling hydraulic power system hanging onto the slot according to an embodiment of the present invention.

FIG. 17 is the analytical view of the pulling hydraulic cylinder hanging on the steel bar inside of the slot according to an embodiment of the present invention.

FIG. 18 is the analytical view of the pulling hydraulic cylinders hanging up the magic mattress according to an embodiment of the present invention.

FIG. 19 is the side view of the lifting hydraulic power system for lifting up the pulling hydraulic power cylinder at the unloaded position according to an embodiment of the present invention.

FIG. 20 is the side view of the lifting hydraulic power system for lifting up the pulling hydraulic power cylinder at the loaded position according to an embodiment of the present invention.

FIG. 21 is the sketch diagram of the pulling hydraulic power cylinder hanging up the magic mattress together with the banister according to an embodiment of the present invention.

FIG. 22 is the sketch diagram showing the magic mattress is put on the wheelchair according to an embodiment of the present invention.

FIG. 23 is the practical sample view of the moving body approaching the wheelchair according to an embodiment of the present invention.

FIG. 24 is the sketch diagram showing the patient remaining the same pose lifting up together with the magic mattress from the wheelchair by hydraulic power systems according to an embodiment of the present invention.

FIG. 25 is the sketch diagram showing the magic mattress is put on the sickbed according to an embodiment of the present invention.

FIG. 26 is the practical sample diagram of the moving body is approached at the sickbed according to an embodiment of the present invention.

FIG. 27 is the sketch diagram showing the magic mattress can be bended so as to keep the patient's pose remaining the same, and lifted up from the sickbed by hydraulic power systems according to an embodiment of the present invention.

FIG. 28 is the practical sample view of the patient is lifted up for crap according to an embodiment of the present invention.

FIG. 29 is the sketch diagram showing the patient's feet can be practiced at the ground according to an embodiment of the present invention.

FIG. 30 is the sketch diagram showing the moving body can be controlled by the remote controller according to an embodiment of the present invention.

FIG. 31 is the top view of the moving body is mounted at a wheelbarrow according to an embodiment of the present invention.

FIG. 32 is the practical sample diagram of the moving body is mounted at a wheelbarrow, and lifted up the patient together with the magic mattress from the wheelchair to move without changing patient's pose according to an embodiment of the present invention.

FIG. 33 is the practical sample diagram of the moving body is mounted at a wheelbarrow, and lifted up the patient together with the magic mattress from the sickbed to move without changing patient's pose according to an embodiment of the present invention.

FIG. 34 is the top view of the moving body is mounted at an electric car according to an embodiment of the present invention.

FIG. 35 is the practical sample diagram of the moving body is mounted at an electric car and lifted up the patient together with the magic mattress from the wheelchair to move without changing patient's pose according to an embodiment of the present invention.

FIG. 36 is the practical sample diagram of the moving body is mounted at an electric car and lifted up the patient together with the magic mattress from the sickbed to move without changing patient's pose according to an embodiment of the present invention.

### THE SYMBOLS OF THE DRAWINGS

1 The magic mattress

1-1 The magic stick

1-2 The soft material of the magic stick

1-3 The axle of the magic stick

1-4 The handle of the magic stick

1-5 The holder of the magic stick

1-6 The hanger for preventing the magic mattress slipped on the sickbed or wheelchair

2 The wheel-type frame of the magic mattress.

2-1 The wheel for the frame

2-2 The fix-plate for the wheel-type frame

2-3 The screw and washer or the welding point

2-4 The hole for putting the handle of the magic stick

2-5 The cover for the magic stick handle

2-6 The hole for inserting the holder of the magic stick

2-7 The safety-belt for patient

2-8 The fixer for the banister's pole

3 The banister

3-1 The wheel-type fixer of the banister

3-2 The folding frame of the banister

3-3 The flexible button of the banister

3-4 The fixing pole of the banister

4 The body of the moving equipment

4-1 The frame of the moving body

4-2 The balance material

4-3 The wheel of the moving body

4-4 The pump of the hydraulic systems

4-5 The controlling box of hydraulic systems

4-6 The hydraulic pipelines and the wires

5 The slot for hanging the pulling hydraulic cylinders

5-1 The steel bar for hanging pulling hydraulic cylinders onto the slot

5-2 The extension slots

5-3 The pulley for the extension slots

5-4 The ragged face of the steel bar for hanging pulling hydraulic cylinders inside of the slot

6 The pulling hydraulic system

6-1 The ring of the pulling hydraulic cylinder

6-2 The cylinder of the pulling hydraulic system

6-3 The arm of the pulling hydraulic

6-4 The flexible button of the hook

6-5 The hook of the pulling hydraulic cylinder

6-6 The shape of the ring before loading

6-7 The shape of the ring after loading

6-8 The control-button of the pulling hydraulic system

7 The lifting hydraulic system

7-1 The cylinder of the lifting hydraulic system

7-2 The welding point in between the lifting hydraulic system and the slot

7-3 The control-button of the lifting hydraulic system

8 The extension hydraulic system

8-1 The cylinder of the extension hydraulic system

8-2 The welding point in between of the extension hydraulic system and the slot

8-3 The control-button of the extension hydraulic system

9 The symbol of the practical samples

9-1 The wheelchair

9-2 The sickbed

9-3 The sitting pose of the patient

9-4 The lying pose of the patient

9-5 The bedpan or water closet

9-6 The wheelbarrow

9-7 The electric car

9-8 The remote controller

### THE DETAILED DESCRIPTION OF EMBODIMENTS

For achieving the aforementioned objectives and effects, the technical means and structures adapted by the present invention have been detailed described the characteristics and functions for the preferred embodiments of the present invention and with the accompanying drawings, which have to be divided by three parts; one is the magic mattress, the others are the moving body and the practical samples as followings.

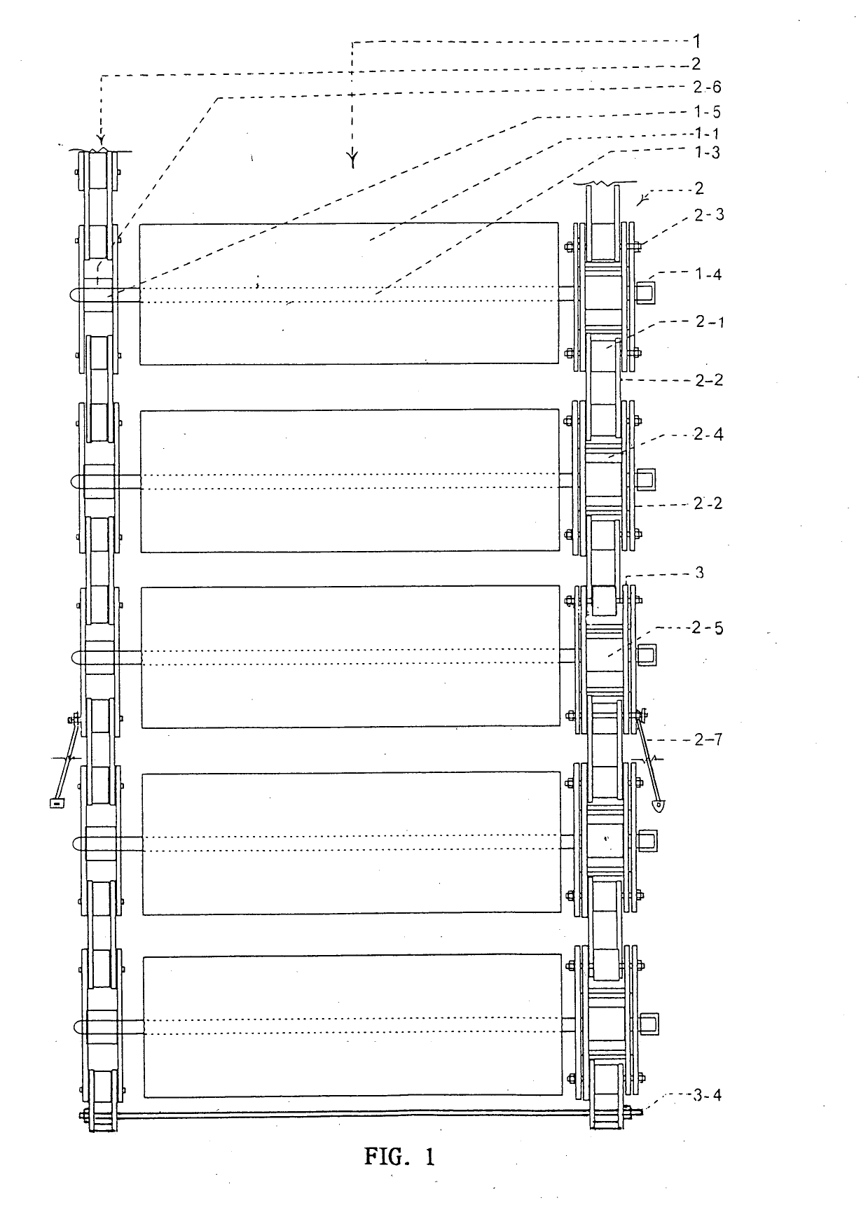

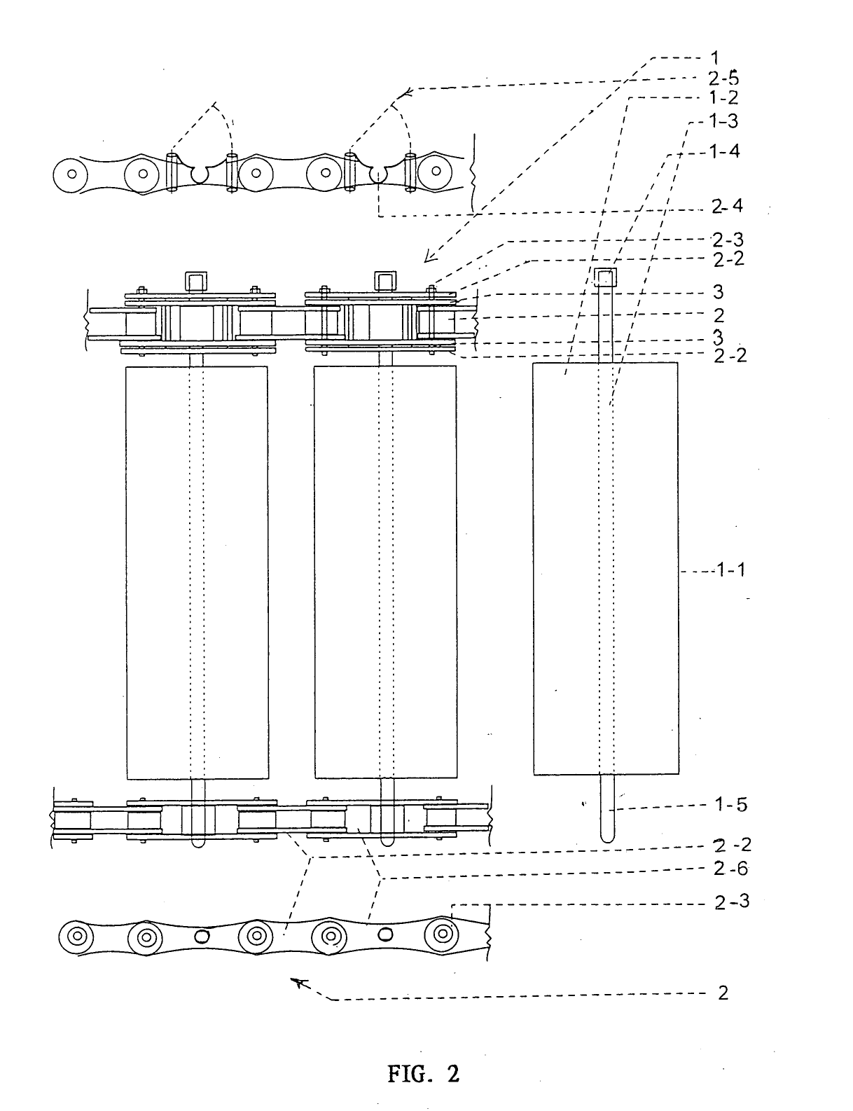

Regarding to the first part of the magic mattress, please refer to FIGS. 1 and 2, which are the top and the analytical view of the magic mattress. From those views, it can be seen that the magic mattress 1 is assembled by the wheel-type frame 2 and the magic sticks 1-1; the steel tube axle 1-3 of the magic stick 1-1 is enveloped by the soft material 1-2, which is used for the cushion, but any other types of cushions can be put on the magic stick 1-1 according to patient's requirements; the handle 1-4 and the holder 1-5 are the revealed part of the soft material 1-2 at each end of the steel tube axle 1-3. From the side view of the frame 2, it shows the frame 2 has two sides; one side has the hole 2-4 for putting the handle 1-4 and it's covered by the cover 2-5, which is used to withdraw the magic stick 1-1 from frame 2 for patient's crap purpose; at the same side of the frame 2, it has a banister 3, which has the same features for the chain as the wheel-type fixer of the banister 3-1, the fixer of which is used to connect with the frame 2, so that, the banister 3 can be bent with the magic mattress 1 by one step to protect the patient at any pose. Moreover, a safety-belt 2-7 is configured at certain locations of the magic mattress 1 to doubly ensure the safety for the patient. The collapsible banister 3 is assembled by the folding frame 3-2 and the flexible button 3-3, and a pole 3-4 is configured at the banister fixer 3-1 so as to prevent the banister 3 falling down accidentally, and the pole 3-4 can be fixed with the pole's fixer 2-8 when the banister 3 is folded. The other side of the frame 2 has the hole 2-6 for inserting the holder 1-5. The magic stick 1-1 together with the frame 2 will be lifted up to sufficiently support and fit with the pose of the patient when the holder 1-5 is pulled up. The banister 3 and the wheel 2-1 of the frame 2 are fixed by the connecting plate 2-2. The screw and washer 2-3 are used for fixing the frame 2 and the banister 3 together, or they can be welded together to be more robust. The magic mattress 1 is used to be put on the wheelchair, sickbed or the wheelbarrow, so as to cooperatively operate with the moving body for the purpose of moving patient without changing patient's pose.

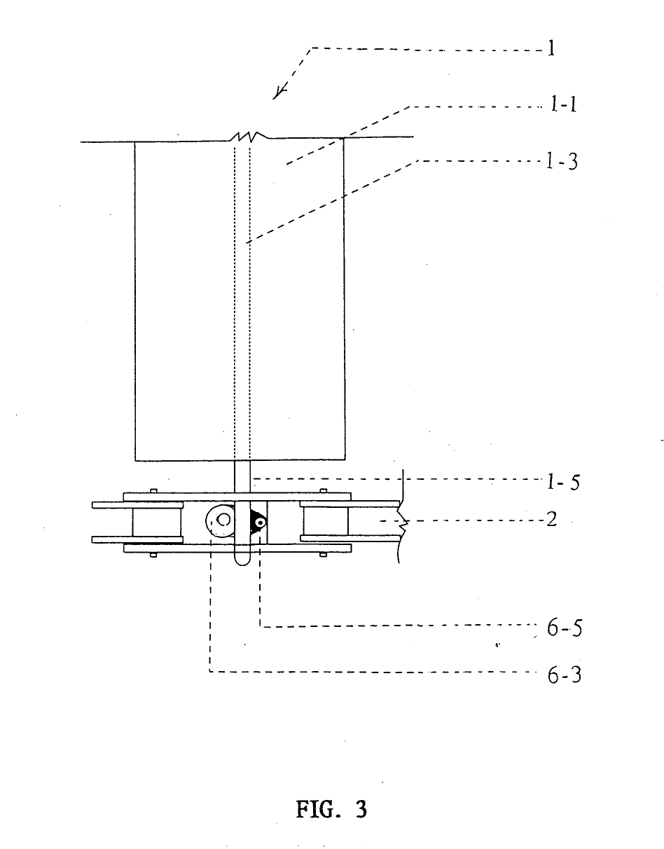

Please refer to FIG. 3, which is the top view of the hooker inserted into the magic mattress frame for holding the magic sticks. From the view of which can be seen that, the holder 1-5 of magic stick 1-1 is inserted into the hole 2-6 of the frame 2; the hook 6-4 of the pulling hydraulic system 5-3 is holding the holder 1-5 of magic stick 1-1 at the hole 2-6 of the frame 2.

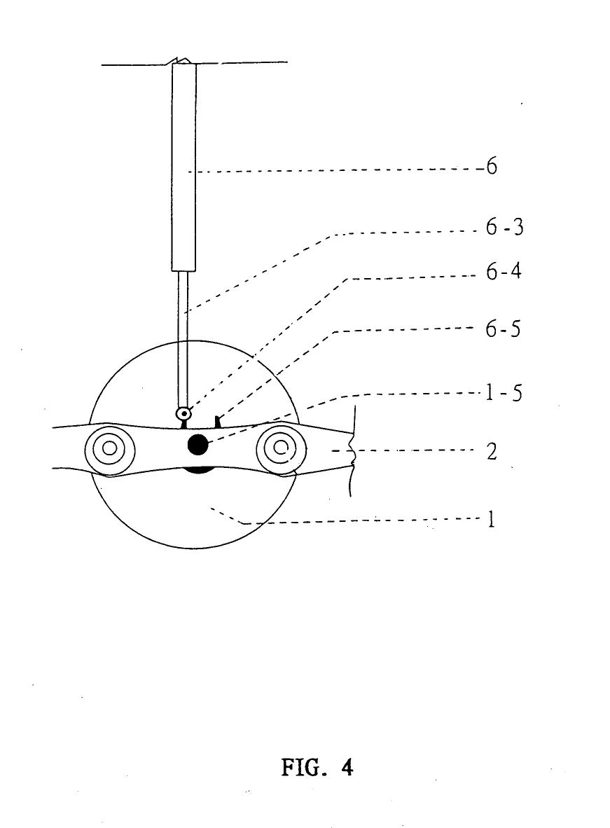

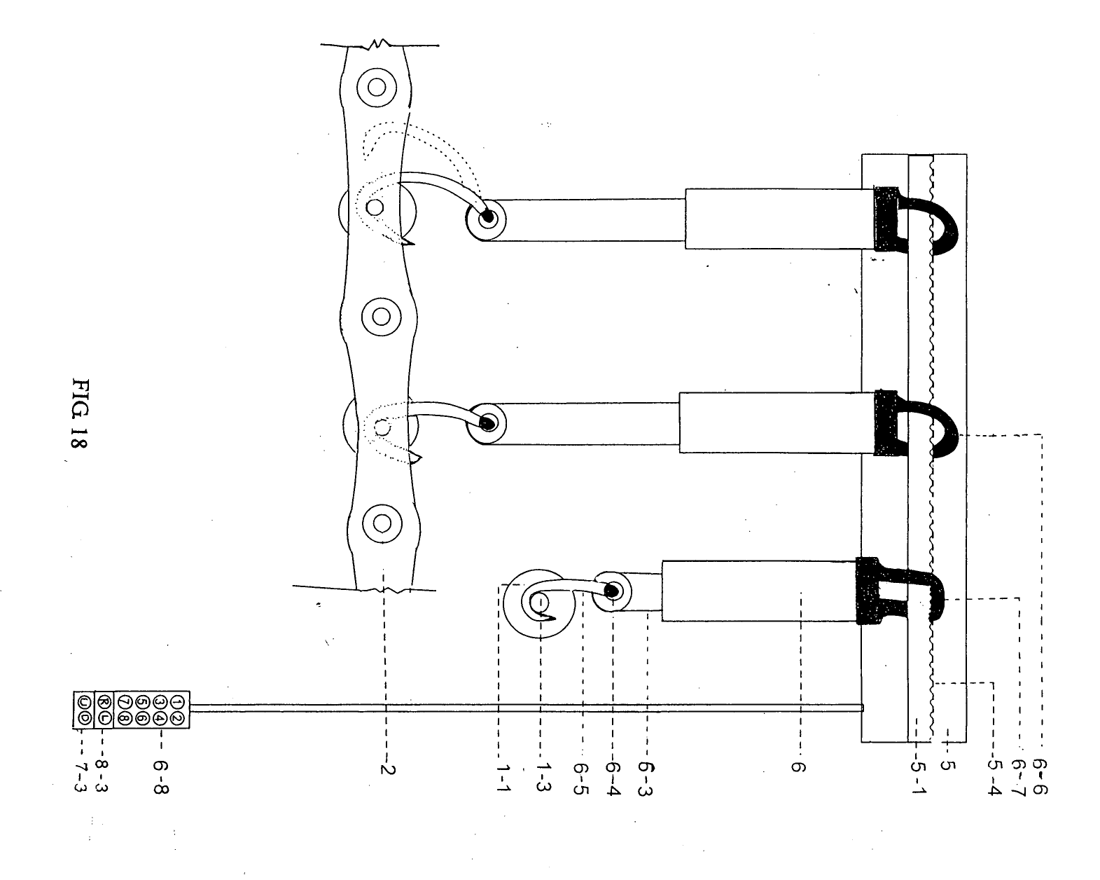

Please refer to FIG. 4, which is the side view of the magic stick pulling up by the pulling hydraulic power system. From the view of which can be seen that the holder 1-5 of magic stick 1-1 is inserted into the hole 2-6 of the frame 2; the hook 6-4 of the pulling hydraulic power system 5-3 is holding the holder 1-5 of magic stick 1-1. The flexible button 6-3 of the hook 6-4 and the side view of the soft material 1-2 of magic stick has be shown clearly. (Please find the detailed descriptions for the flexible button 6-3 from FIG. 18).

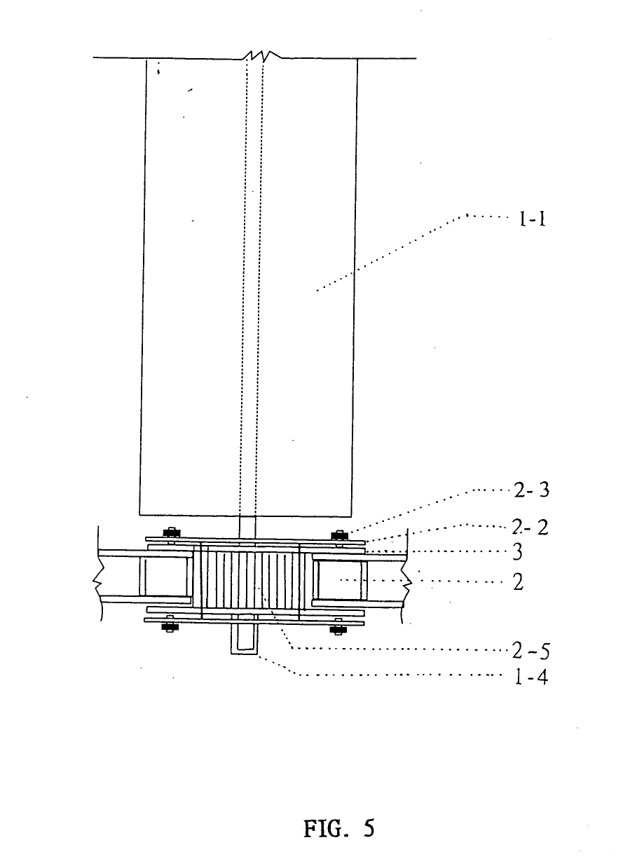

Please refer to FIG. 5, which is the top view of the handle putting on the magic mattress frame covered by its cover. From the view of which can be seen that the handle 1-4 of the magic stick 1-1 is put on the hole 2-4, and the cover 2-5 is fixed at the frame 2.

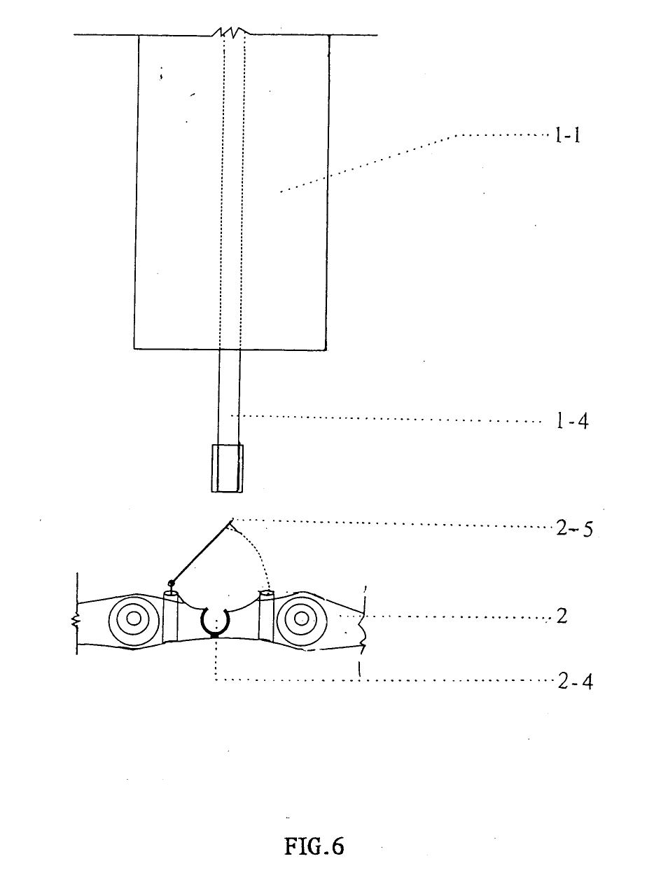

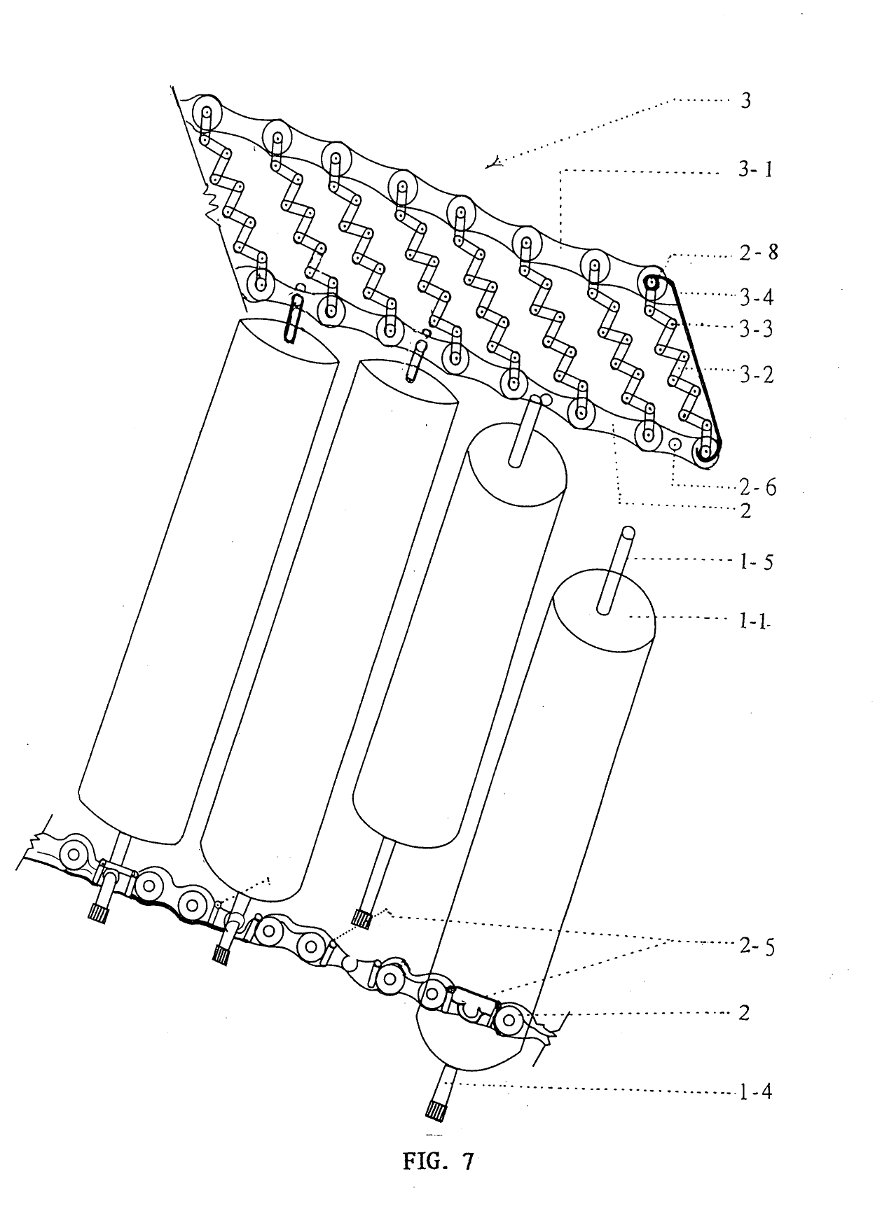

Please refer to FIGS. 6 and 7, which are the sketch diagram and the analytical view of the magic stick withdrawing from the magic mattress. From these two views, it can be seen that the magic stick 1-1 is put at the hole 2-4 of the magic frame 2, and the cover 2-5 can be opened so as to withdraw the magic stick 1-1 from the frame 2 at patient's ass portion for crap, or at any other appropriate portion for patient to take shower etc. At that time, the other magic sticks 1-1 and banister 3 are remaining at their positions.

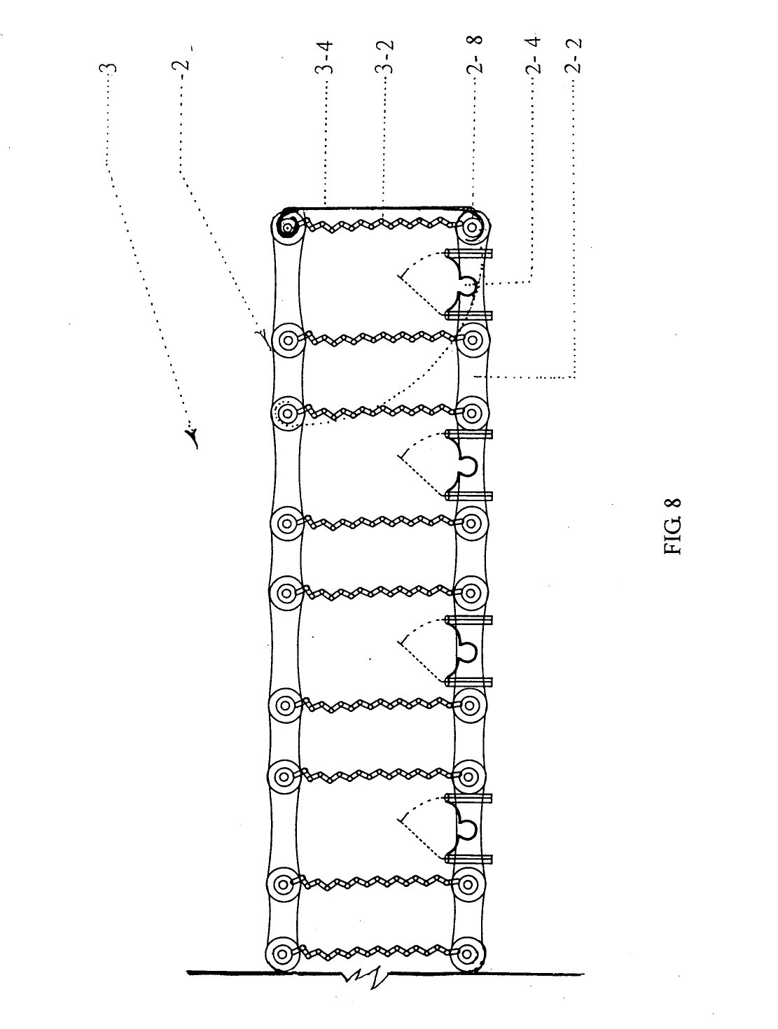

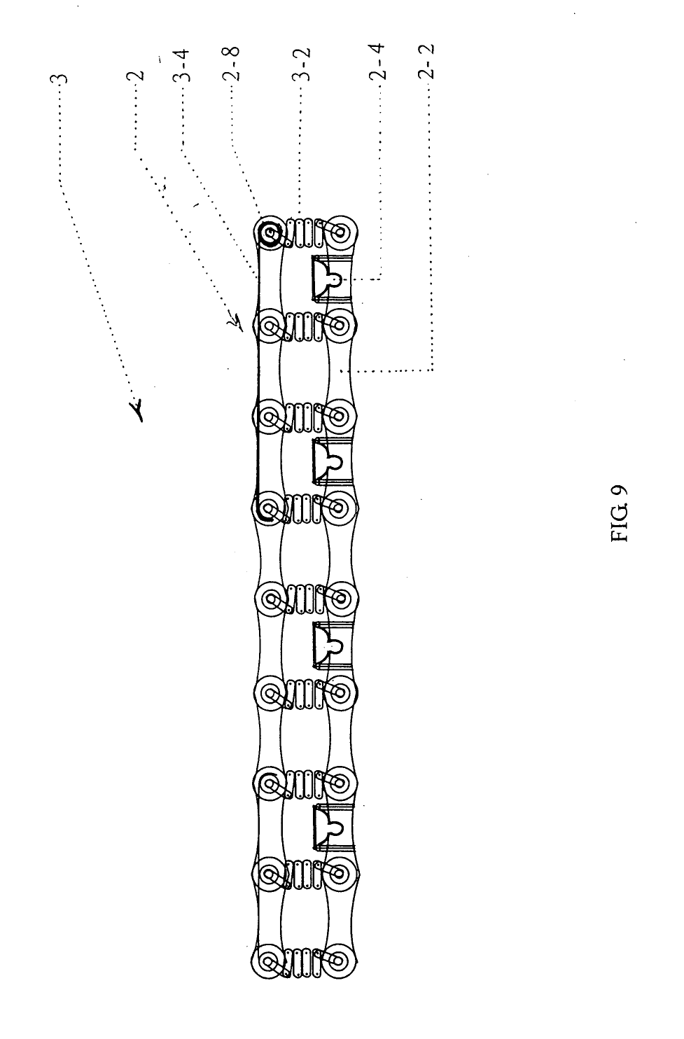

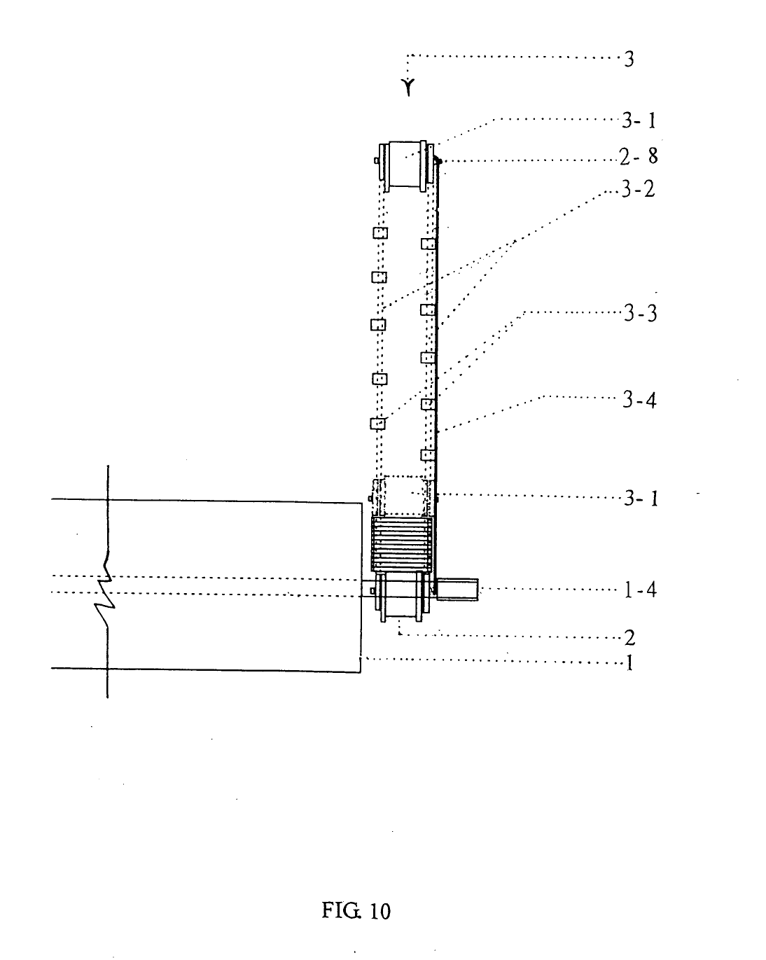

Please refer to FIGS. 8, 9 and 10, which are the top views of the banister at its upward and folding position, and the side view of the banister at both upward and folding position. From these views, it can be seen that banister 3 are assembled with many folding frames 3-2 and the flexible buttons 3-3; the banister's fixer 3-1 has the same chain-type as the magic mattress frame 2, which are connected with the folding frames 3-2, which means that the banister 3 can be bent with the magic mattress 1 at one step; two folding frames 3-2 are installed at both sides of the magic mattress frame 2, and the banister fixer 3-1, the banister 3 of which can be folded at the magic mattress frame 2 together with its pole, and the pole of which will be dropped when the banister 3 is upright; it can be fixed at the pole fixer 2-8 and the banister fixer 3-1 when the banister 3 is in the folding position, so that, it will not interfere with the patient for getting on or off from the magic mattress 1.

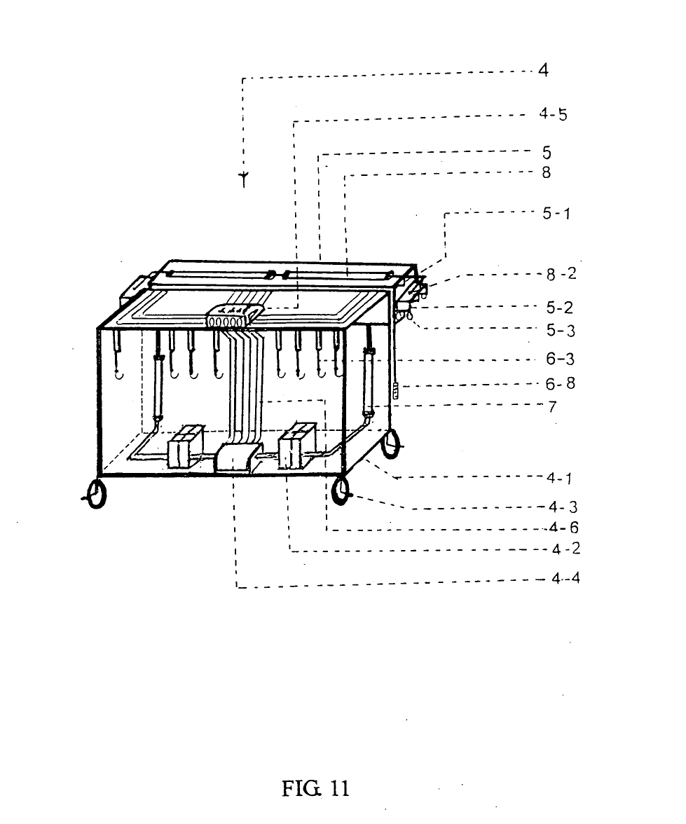

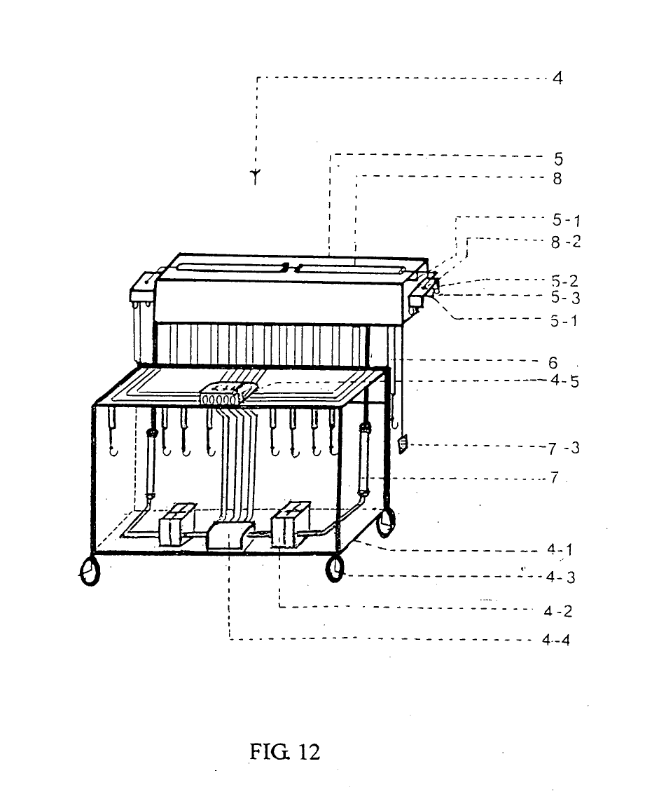

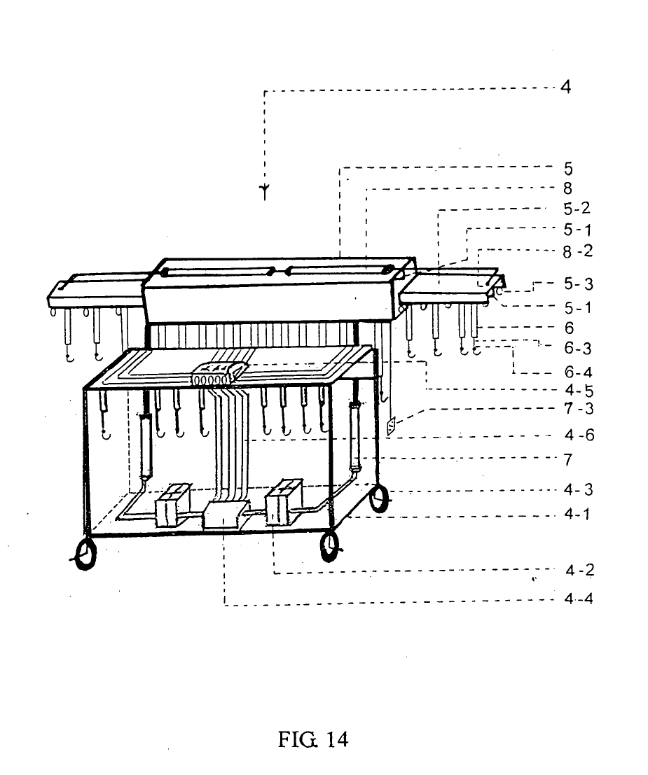

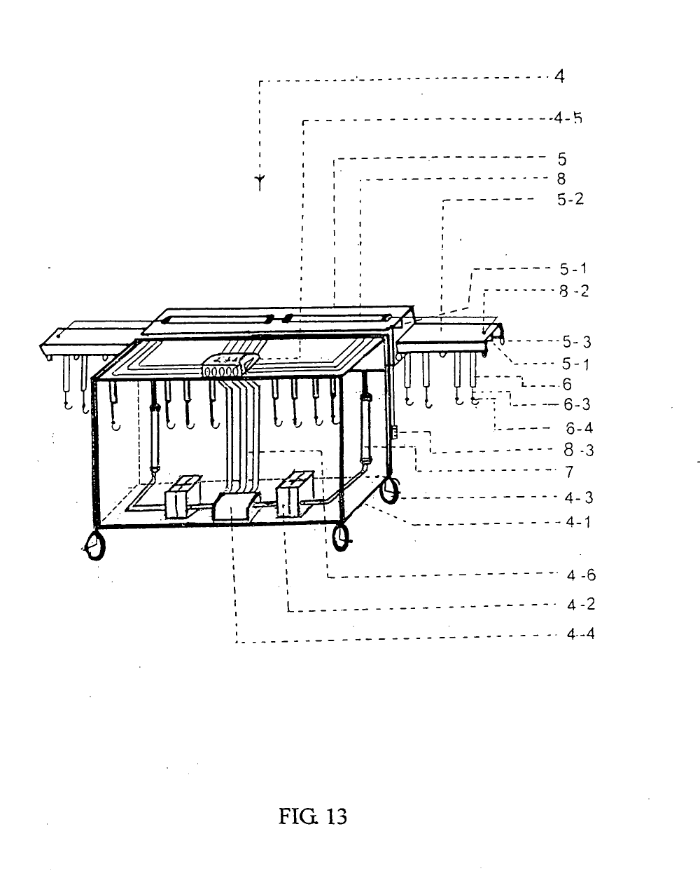

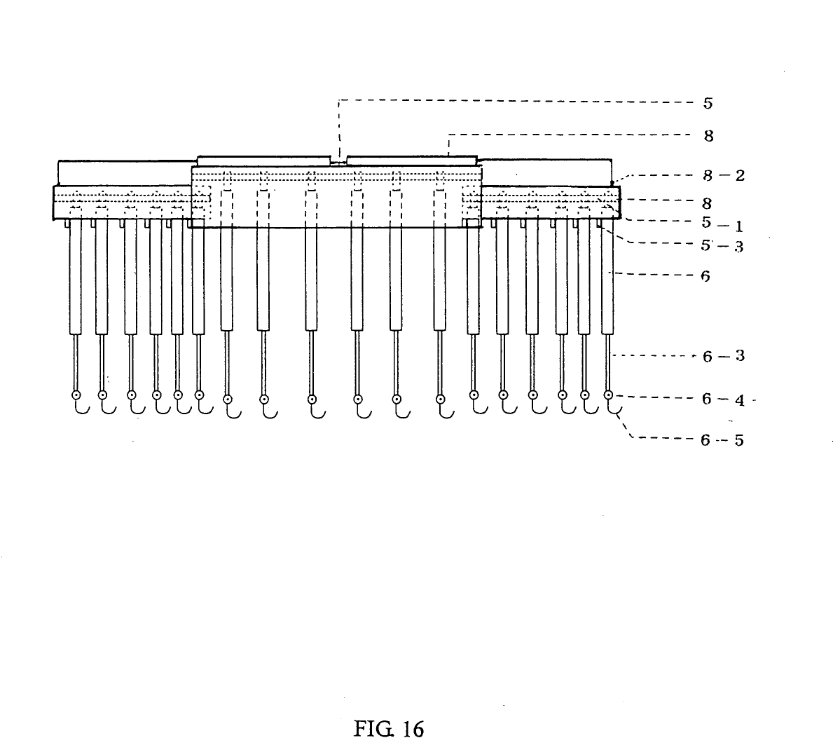

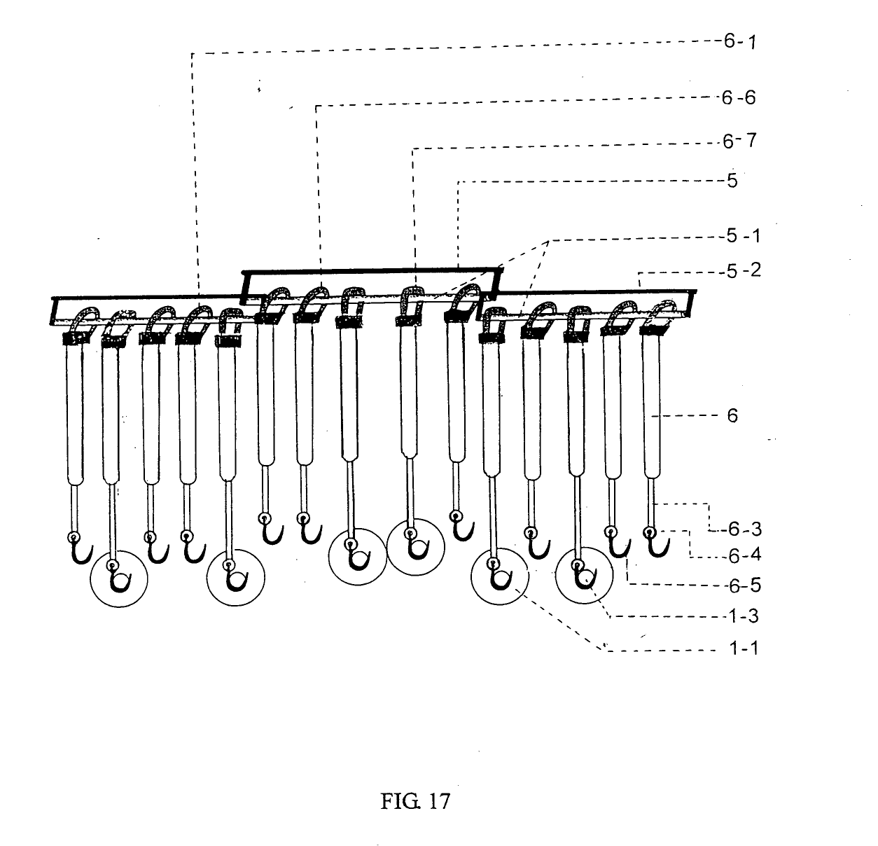

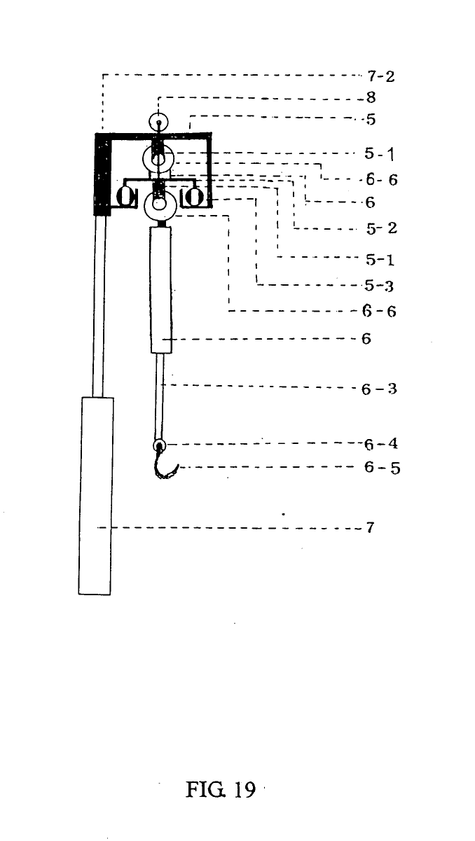

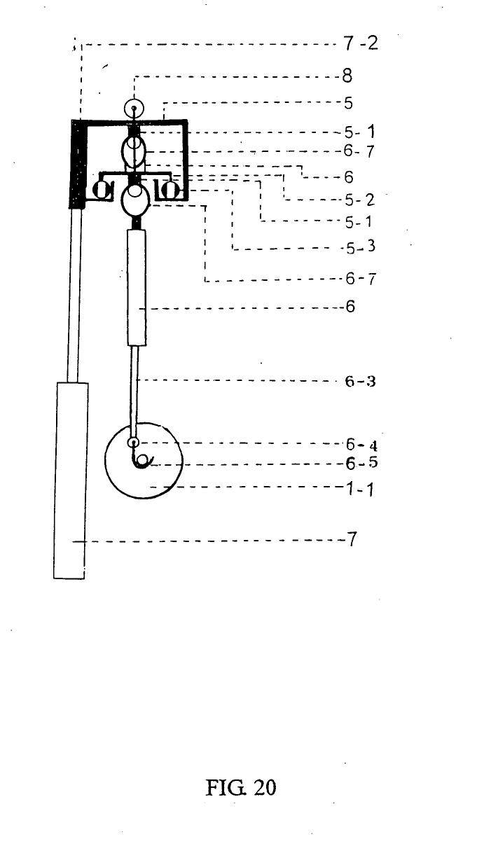

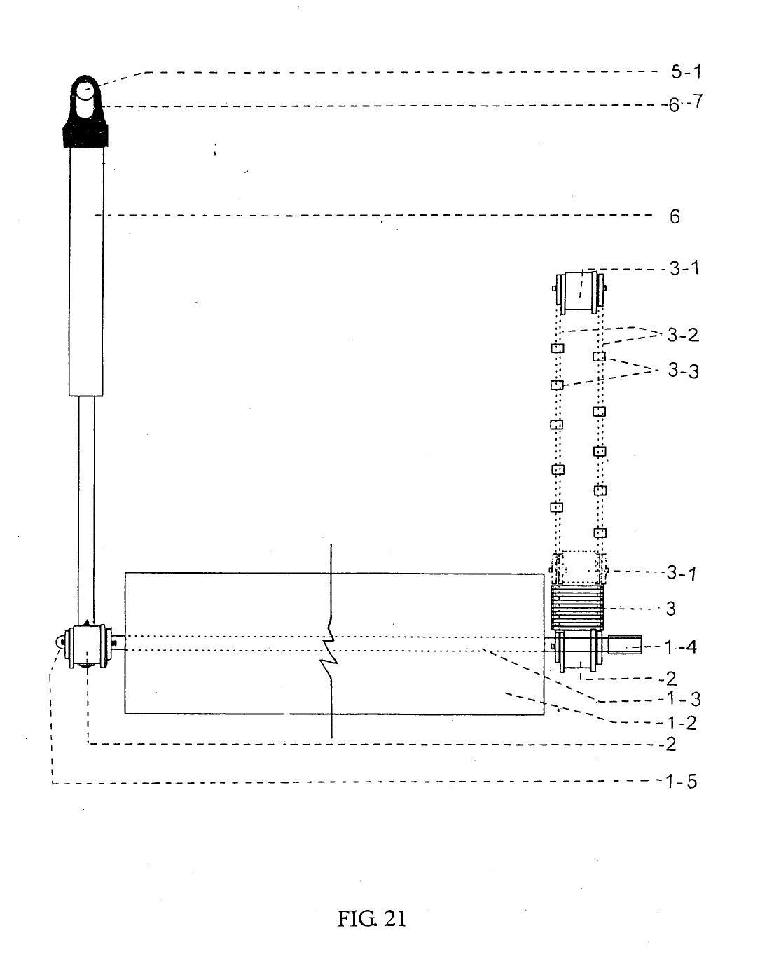

Regarding to the second part of the moving body, from FIG. 11 to 21 are the detailed specifications, functions and the controlling systems, which are explained in details as followings.

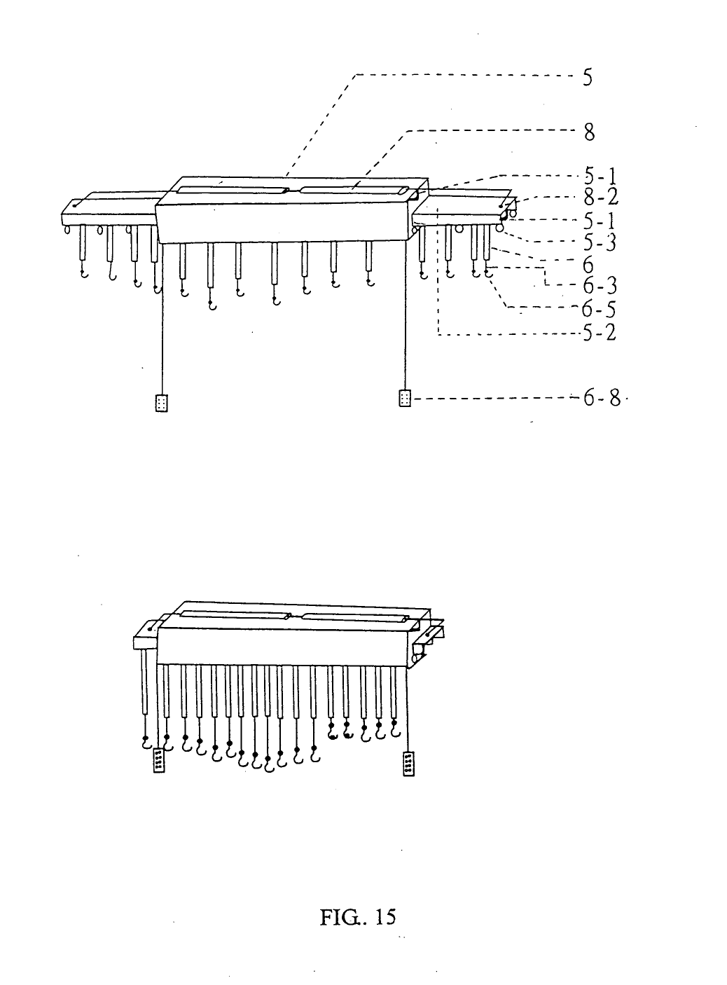

Please refer to FIGS. 11, 12, 13 and 14, which are the stereoscopic views of the moving body, wherein the stereoscopic view of the slot shows that the slot is used for hanging the pulling hydraulic cylinders lifted up by the lifting hydraulic power system, and stretched by the extension power system, and both of them are lifted up by the lifting hydraulic power system; and, the extension slots are stretched by the extension power system at the moving body. From these views can be seen that the moving body 4 comprises the frame 2, the balance material 4-2, the wheel of the moving body 4-3, the pump of the hydraulic systems 4-4, the controlling box of hydraulic systems 4-5, the hydraulic pipelines and the wires 4-6, the slot 5, the extension slots 5-2 and the pulling 6, lifting 7 and extension 8 hydraulic power systems etc., (the detailed specifications of the slot and the extension slots are described in FIG. 15 to FIG. 21). The slot 5 and the extension slots 5-2 are used to hang the pulling hydraulic power cylinders 6, which is enveloped by the steel tube 5-1 with the ring 6-1. The cylinders 6-1 and their arms 6-3 and the hooks 6-5 are used to hang up the magic stick 1-1 to approach the patient's body, so as to keep the patient's pose without change. The flexible button of the hook 6-4 is used to help the hook 6-5 to be inserted into the hole 2-4 for holding the magic stick 1-1 easily. The control-buttons of the hydraulic systems are 6-8, 7-3 and 8-3, which are installed on one controller at both side of the slot 5.

Please refer to FIGS. 15, 16, 17, 18, 19, 20 and 21, which are the stereoscopic views of the slot for hanging the pulling hydraulic cylinders and the extension slots stretched by the extension power system, the perspective view of the pulling hydraulic power system hanging onto of the slot, the analytical view of the pulling hydraulic cylinders hanging on the steel bar inside the slot, the analytical view of the pulling hydraulic cylinders hanging up the magic mattress, the side view of the lifting hydraulic power system for lifting up the pulling hydraulic power cylinders at both the unloaded and loaded positions, and the sketch diagrams of the pulling hydraulic power cylinders hanging up the magic mattress. These figures of which are the detailed specifications of the slot at the moving body. From these views can be seen that the slot 5 and the extension slot 5-2 are fixed at the welding points 7-2 on the lifting hydraulic system 7-1. The pulling hydraulic system 6 and its cylinders 6-2 are hanged with the ring 6-1 enveloping at the steel bar 5-1 inside the slot 5 and the extension slots 5-2. Due to the extension hydraulic systems 8 are mounted on the top of slot 5 at each end, the pulling hydraulic system 6 inside the slot 5 can lift up the magic mattress 1 at the middle of the slot 5 when the extension slot 5-2 is stretched. Two control-buttons of the pulling hydraulic system 6-5 are installed at each side of the slot 5, which are used to control the pulling hydraulic cylinders to lift up the magic sticks for approaching the pose of the patient easily. From the perspective and the analytical view of the pulling hydraulic power system hanging inside of the slots show that the pulling hydraulic cylinders 6-1 are hanging at the steel bar 5-1 inside the slots 5 and 5-2 with the rings 6-1. For the consideration of these rings 6-1, they can be shafted to find the suitable positions for the magic stick's holders 1-5 at certain locations. However, those rings 6-1 have to be blocked at the steel bar 5-1 without slipping accidentally when those magic sticks 1-1 are pulled up during approaching the patient's pose. The rings 6-1 should be made of elastic plate metal, etc., and the surface of the steel bar 5-1 should be treated with rough or toothed materials 5-4. From these detailed diagrams can be found that the rings 6-1 can be moved easily at the steel bar 5-1 with its shape 6-6, and the shape can be changed to 6-7 when the ring 6-1 is loaded with magic mattress 1 blocked at the steel bar 5-1, and it will be fixed at the steel bar 5-1 for ensuring to keep the patient's pose without change because of the ragged face 5-4 of the steel bar 5-1. For describing the detailed specifications of the pulling hydraulic system 6 inside of the slot 5 and 5-2 more clearly, please refer to the side view of the rings 6-1, which shows the differences between the loaded or unload positions, and the sketch diagrams illustrate the functions and the procedures for hanging the magic sticks 1-1 up by pulling hydraulic power system 6, and the magic mattress 1 will be lifted up by the lifting hydraulic power system 7 and the rings 6-1 are stopped at the ragged face 5-4 of the steel bar 5-1.

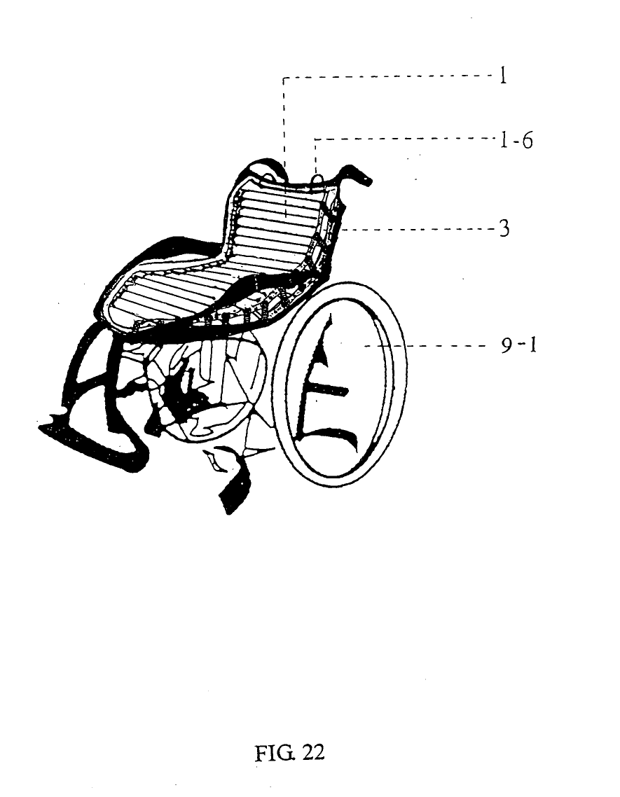

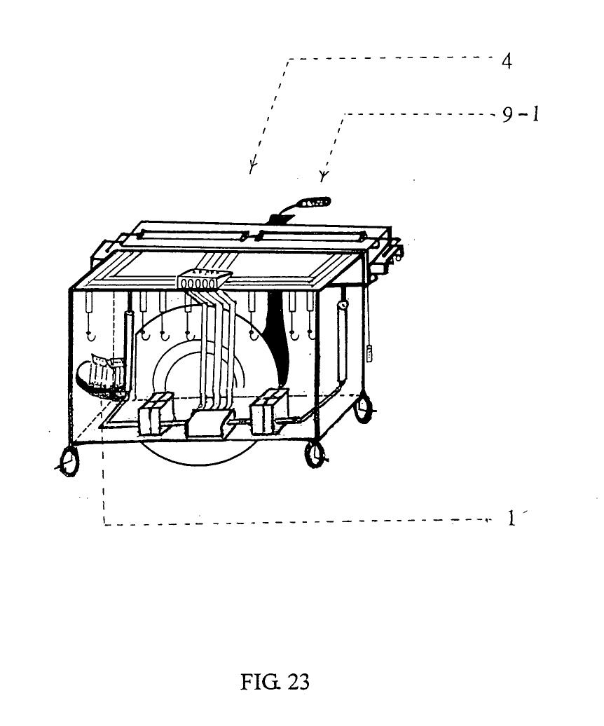

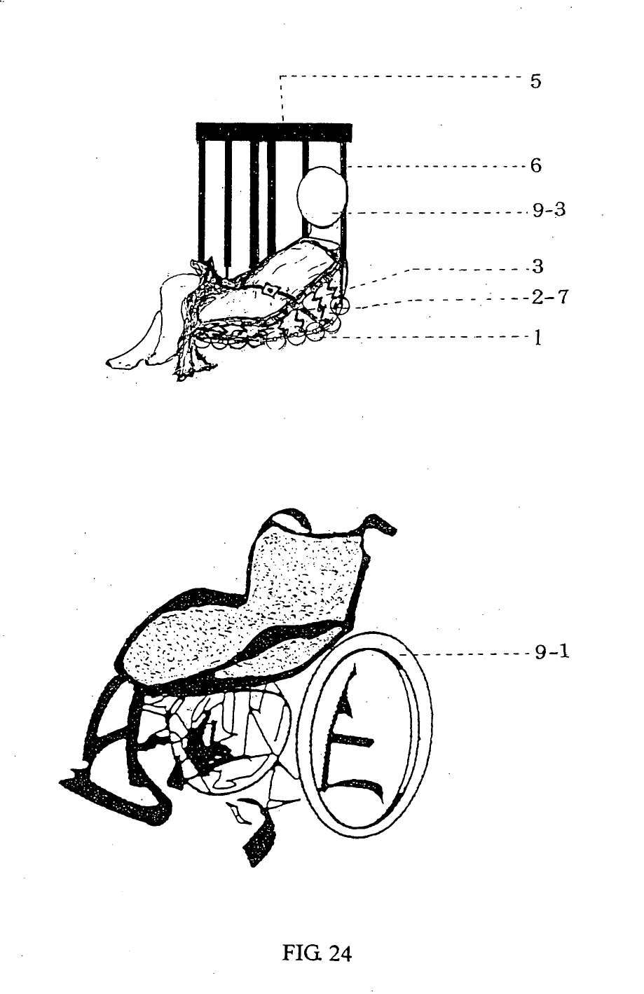

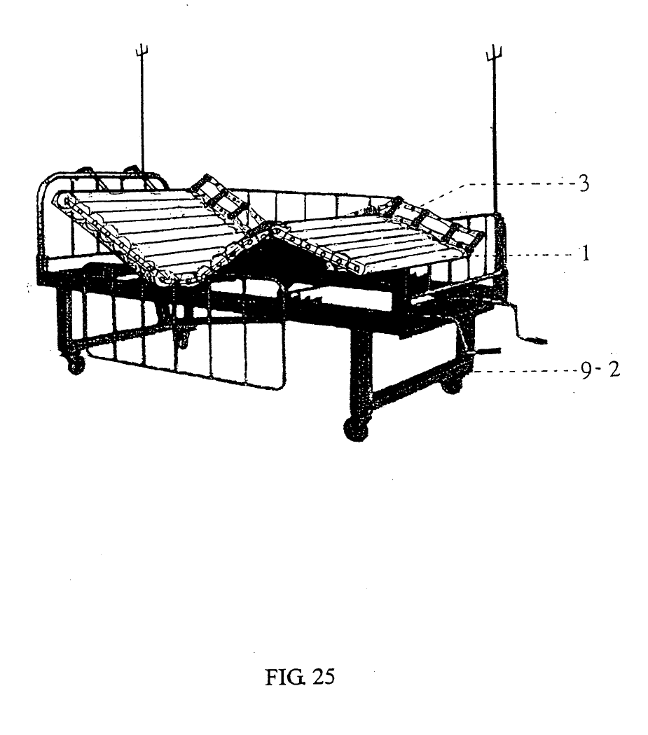

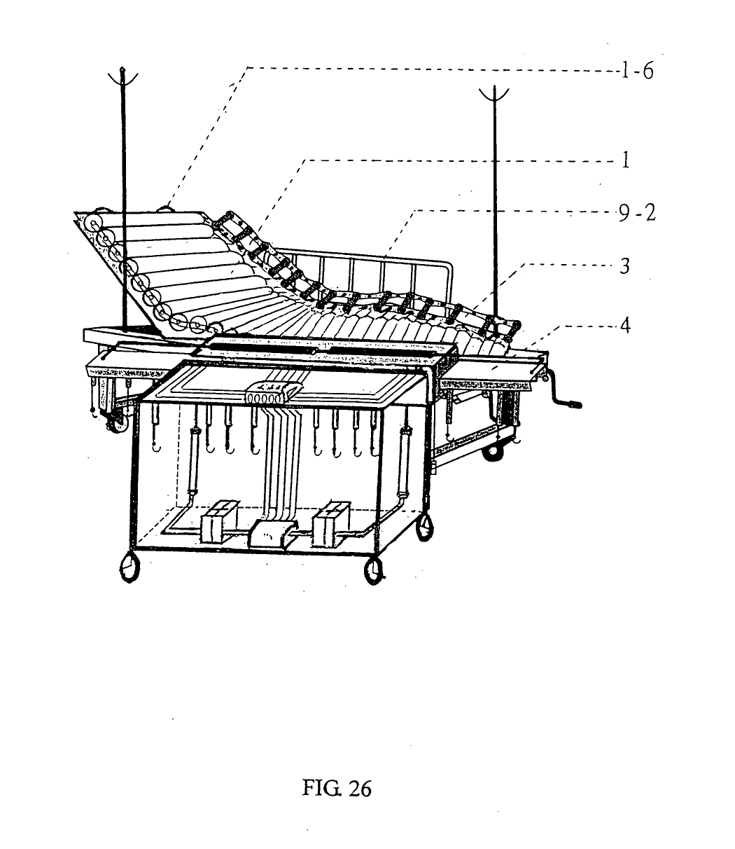

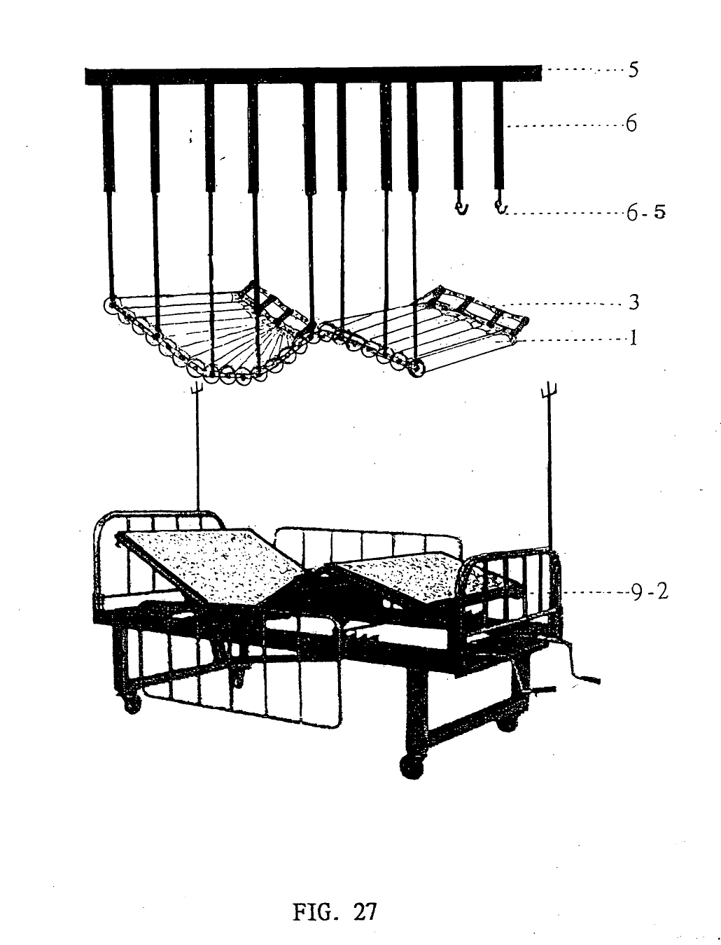

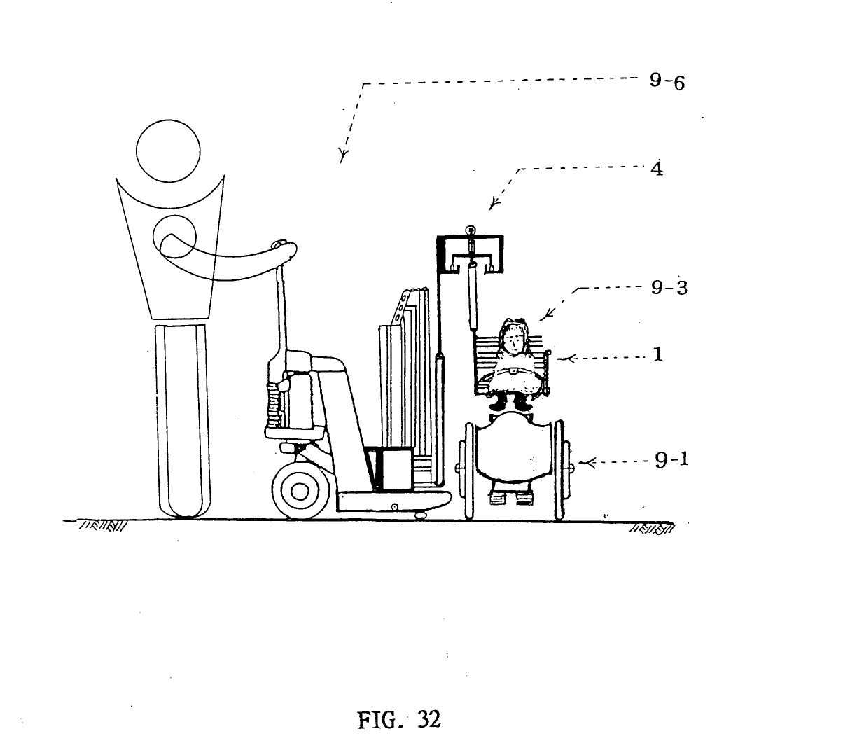

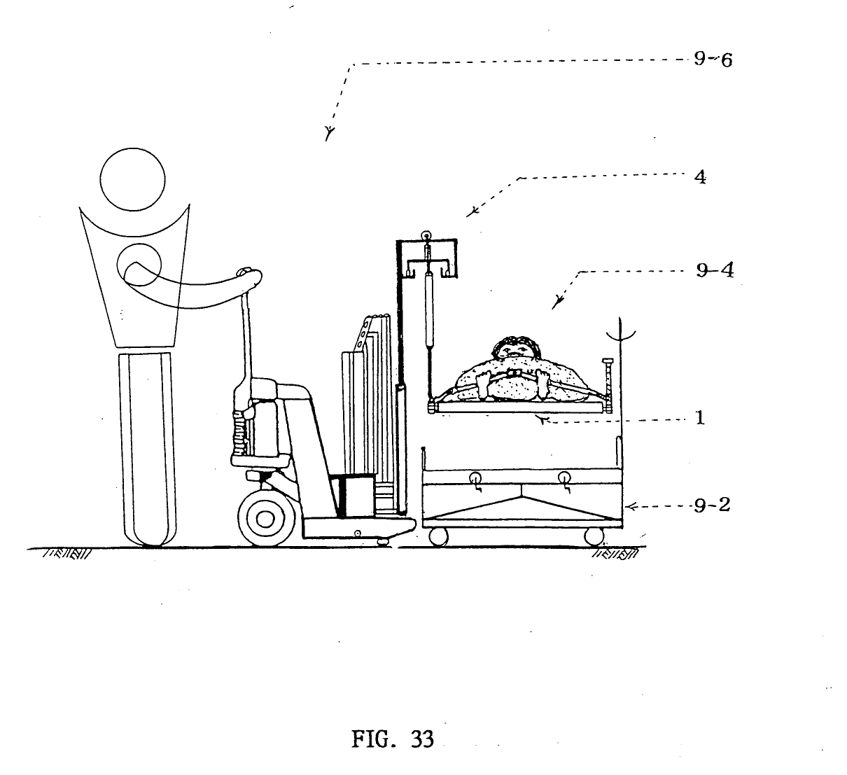

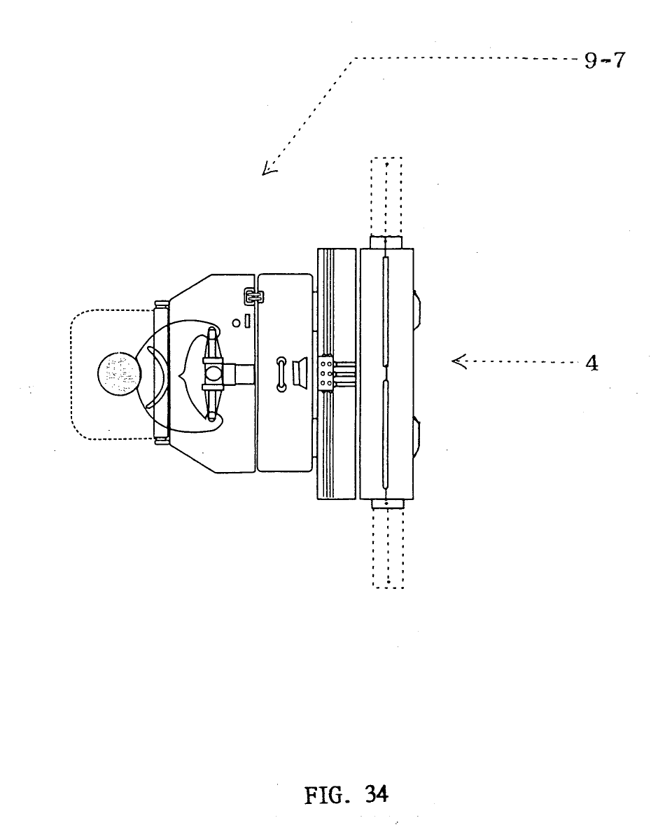

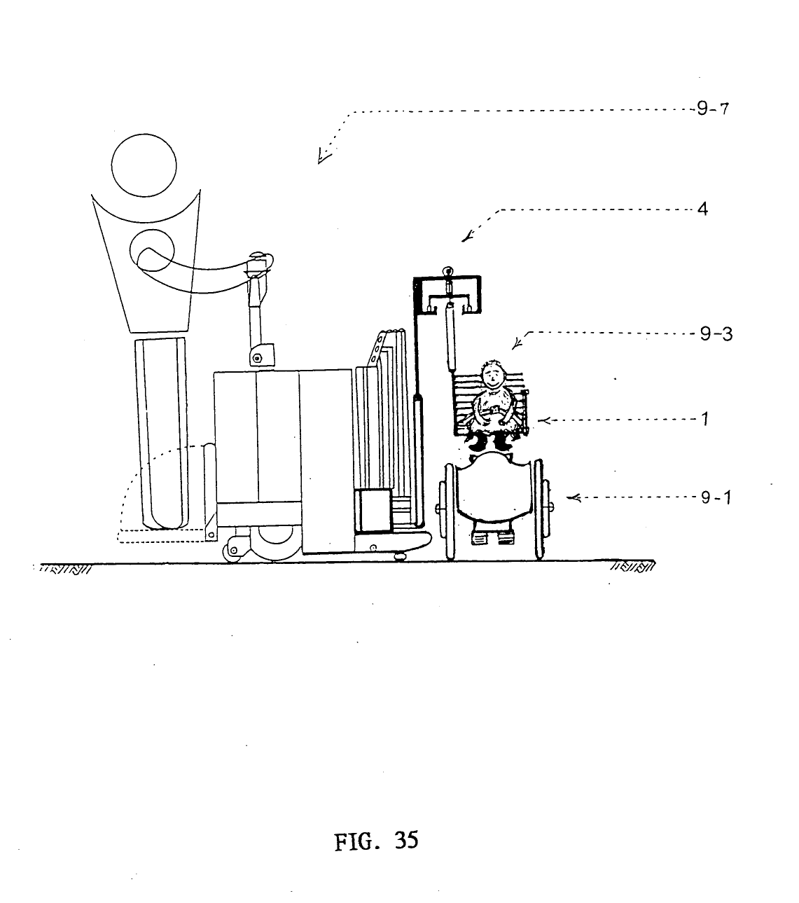

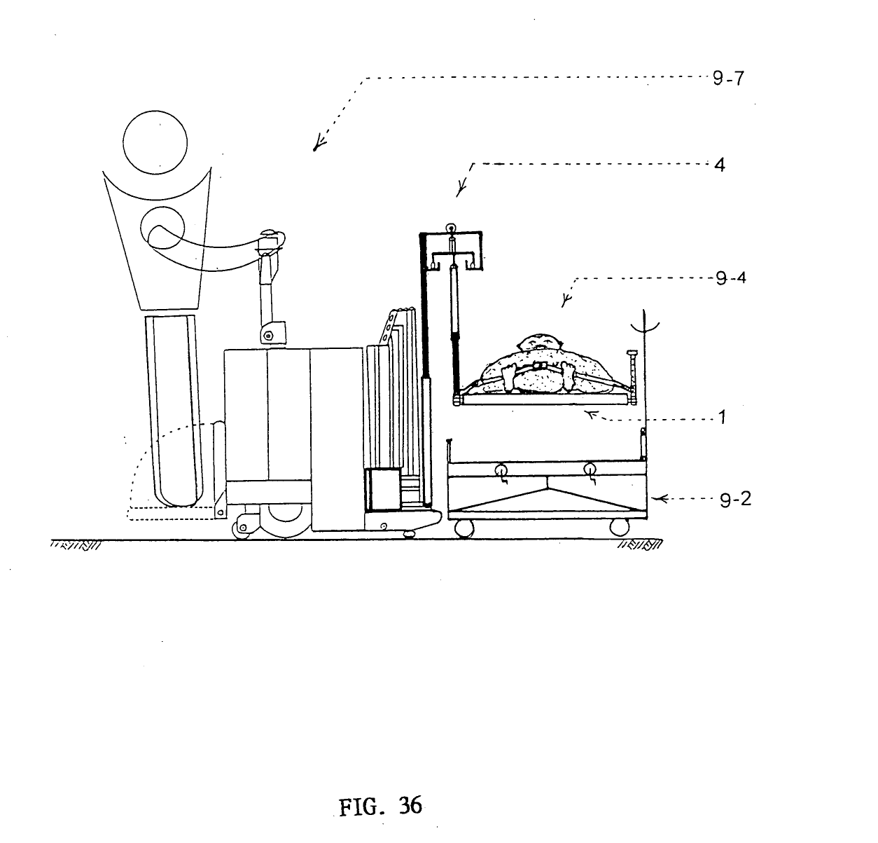

The last part is the practical sample views of the present invention from FIG. 22 to FIG. 36 as followings.

Please refer to FIGS. 22, 23, 24, 25, 26 and 27, these views are the sketch diagrams showing the magic mattress putting on the wheelchair; the practical sample views of the moving body being approached at the wheelchair, or sickbed; the sketch diagrams showing the magic mattress together with the patient being pulled up from the wheelchair or sickbed by lifting hydraulic power system. From these views can be found that the size of the magic mattress 1 is fitted to the wheelchair, or sickbed, and has been put on the wheelchair or sickbed in advance, so that the patient can sit or lie on it. The hanger 1-6 is used for preventing the magic mattress from slipping on the wheelchair or sickbed, and the safety-belt 2-7 is installed at the appropriate position of the magic mattress frame 2. The worker pushes the moving body 4 to approach the wheelchair or sickbed, wherein the patient is already staying on the magic mattress 1; then, holds the pulling hydraulic cylinder 6-2 to move the ring 6-1 to hook the magic stick holder 1-5 with the hook 6-4; next, pushes the control-button 6-8 of the pulling hydraulic system 6 to pull the magic mattress stick 1-1 up to meet with the patient's body. After having bent the magic mattress 1 at some necessary locations, the magic mattress 1 should be march the body of the patient, so as to support the patient' body for remaining the patient's pose and keeping them at original position. Next, the worker pushes the control-button 7-3 of the lifting hydraulic system, and the slot 5 and the extension slots 5-2, which are hanged with the pulling hydraulic cylinders 6-1 linked with the magic mattress 1 and the patient with their arms 6-3 to be lifted up by the lifting hydraulic power system 7. The patient together with magic mattress 1 can be moved away right after leaving the wheelchair 9-1, sickbed 9-2 by the wheels 2-1 of the moving body 4 without changing patient's pose.

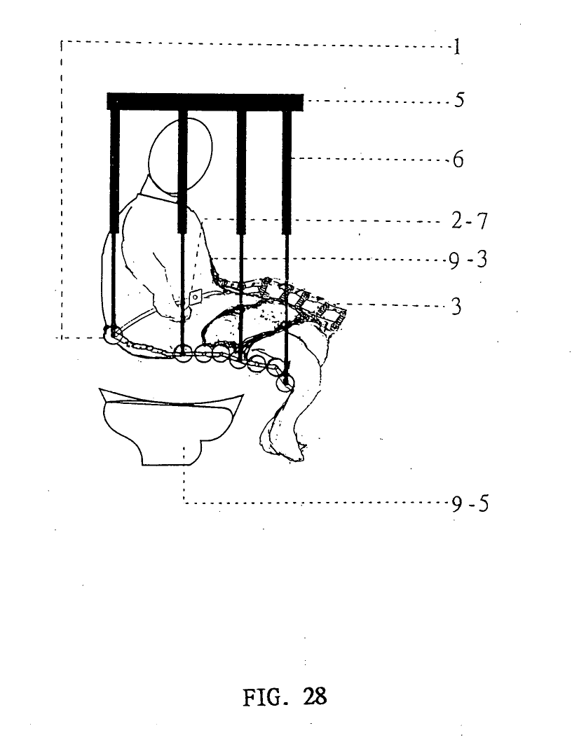

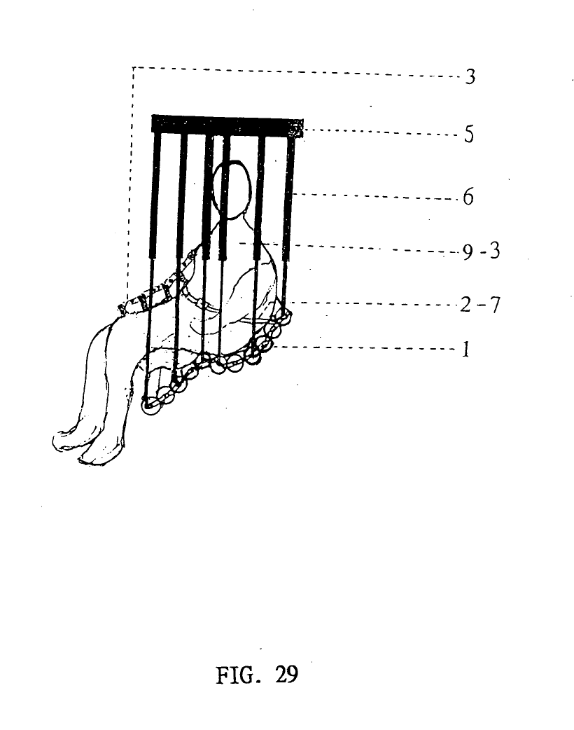

Please refer to FIGS. 28 and 29, which are the practical sample views of the patient for being lifted up for crap, and the sketch diagram shows that the patient's feet can be practiced at the ground. From these views can be seen that the patient 9-3 can sit on the magic mattress 1 held by the pulling hydraulic system 6, and the lifting hydraulic system 7 will lift up the magic mattress 1 together with the patient. These sticks 1-1 at patient's ass part have been withdrawn from magic mattress 1 already. The patient can sit on the bedpan or water closet 9-5 for crap, taking shower or, changing cloth etc. The patient can also relax their legs on the ground, sitting near by the dining table or writing on the desk with their feet at the ground comfortably.

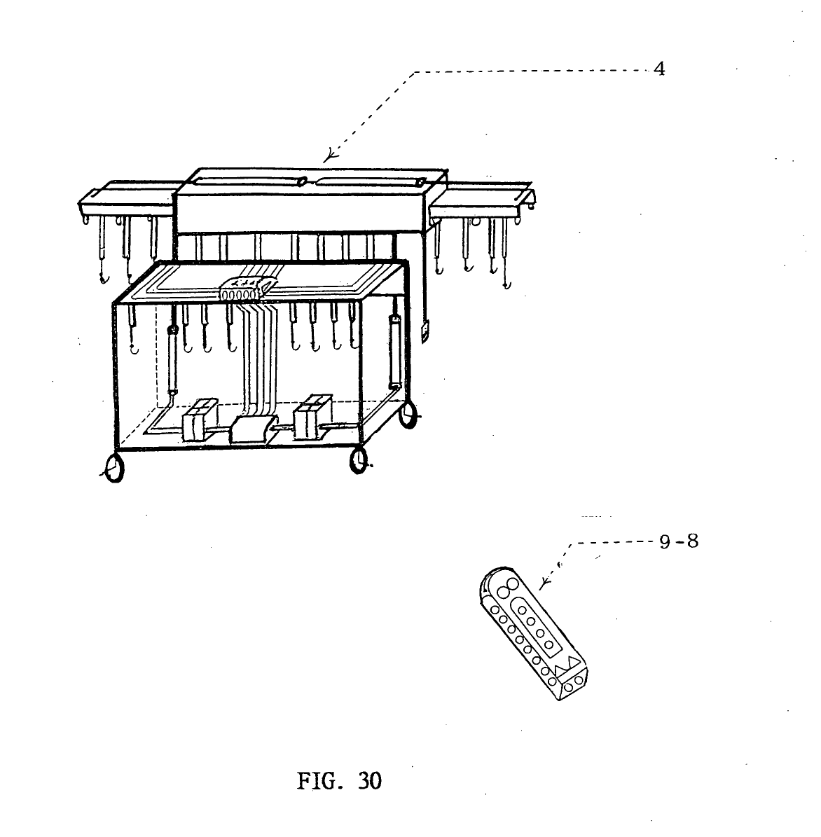

Please refer to FIG. 30, which is the sketch diagram showing the moving body can be controlled by the remote controller. From this view can be seen that the remote-control systems are very popular in the fields of hydraulic and motor driving systems. The moving body 4 comprises the pulling hydraulic system 6, lifting hydraulic system 7 and the extension hydraulic systems 8, and the wheels 4-3 of the moving body 4 can be installed with the remote-control system, so that the patient can use the remote controller 9-8 to control these systems himself or herself without any other people to be involved if he or she is skilled in those procedures, but the worker has to help the patient to withdraw the magic sticks 1-1 in advance for crap.

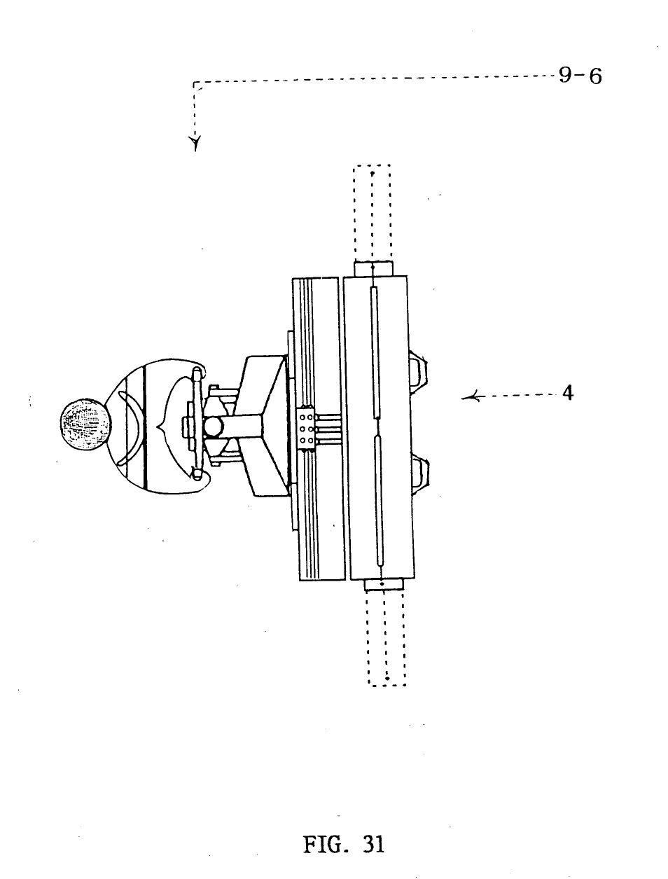

Please refer to FIGS. 31, 32, 33, 34, 35 and 36, which are the top view of the moving body being mounted at a wheelbarrow or a electric car, the practical sample diagram of the moving body being mounted at a wheelbarrow or an electric car, and the patient together with the magic mattress being lifted up from the wheelchair or sickbed to move away without changing patient's pose. From these views can be found that the moving body 4 is mounted at the wheelbarrow 9-6 or the electric car 9-7. The lifting hydraulic system 7 lifted up the slot 5 and the extension slots 5-2, which has made the pulling hydraulic system 6 holding the patient's body to keep the patient's pose remaining the same, and the wheelbarrow 9-6 or the electric car 9-7 can carry the patient together with the magic mattress 1 away right after having left the wheelchair 9-1 or the sickbed 9-2. These procedures are controlled by the wheelbarrow pusher or the electric car driver.

The many features and advantages of the present invention are apparent from the written description and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What the invention claimed is:

1. A moving patient equipment comprising
a magic mattress; and,
a moving body,
wherein the equipment can move the patient without changing patient's pose by the interaction of the magic mattress and the moving body with each other.

2. The moving patient equipment of claim 1, wherein the magic mattress comprises:
a magic mattress frame, which employs the bending feature of the chain to be configured as the frame at each side, and has the holes for inserting the magic stick's holders at one side, wherein the holes are used for putting the magic stick's handles at opposite side;
a plurality of magic sticks are lined up in the middle of the frames, and the magic sticks of which are made by iron tube covered with soft materials, each end of the magic sticks have the handle and the holder, wherein the magic sticks can be withdrew from the holes of the magic mattress frame;
a flexible banister is installed at one side of the magic mattress frame with the chain frame, so as to bend with the magic mattress frame with the same step;
a safety-belt installed at the certain points of the magic mattress frame.

3. The moving patient equipment of claim 1, wherein the magic mattress is put on a stretcher, a wheelchair or a sickbed.

4. The moving patient equipment of claim 1, wherein the moving body comprises:
a major frame of the moving body, which has four wheels at its bottom;
a panel of hydraulic systems; and two individual controlling boxes for the hydraulic systems;
the pump for the hydraulic systems and its wires and pipelines;
a group of the pulling hydraulic systems with hooks;
two extension hydraulic systems;
two lifting hydraulic systems;
a slot for hanging pulling hydraulic system; and
two extension slots for hanging pulling hydraulic systems.

5. The moving body of claim 4, wherein the two extension slots are installed inside the slot, and stretching by two extension hydraulic systems at the top of the slot.

6. The moving body of claim 4, wherein the pulling hydraulic systems are hanging at the ragged face of the steel bar inside both the slot and the extension slots.

7. The moving body of claim 4, wherein the ring of the pulling hydraulic system is made by springy plate metal, netted metal, or special plastic material.

8. The moving body of claim 4, wherein the pulling hydraulic cylinders are connected with flexible hooks for pulling up the magic stick holders, and the hook of which can be used of the clipping type or is a magnetic manner.

9. The moving patient equipment of claim 1, wherein the moving body can be mounted at the electric car or the wheelbarrow.

10. The moving patient equipment of claim 1, wherein the hydraulic power systems can be controlled by wire-control, remote-control or program-control system.
